(19) United States
(12) Patent Application Publication
(10) Pub. No.: US 2017/0372417 A1
(43) Pub. Date: Dec. 28, 2017

(54) DIGITAL ASSET ACCOUNT MANAGEMENT

(71) Applicants: Sivanarayana Gaddam, Santa Clara, CA (US); Gyan Prakash, Foster City, CA (US); Ajit Gaddam, Sunnyvale, CA (US); Phillip Kumnick, Phoenix, AZ (US); Min Wang, Menlo Park, CA (US); Dean Galland, Saratoga, CA (US)

(72) Inventors: Sivanarayana Gaddam, Santa Clara, CA (US); Gyan Prakash, Foster City, CA (US); Ajit Gaddam, Sunnyvale, CA (US); Phillip Kumnick, Phoenix, AZ (US); Min Wang, Menlo Park, CA (US); Dean Galland, Saratoga, CA (US)

(21) Appl. No.: 15/195,797

(22) Filed: Jun. 28, 2016

(51) Int. Cl. G06Q 40/02; G06Q 20/06

(52) U.S. Cl. CPC G06Q 40/025; G06Q 20/065

(57) ABSTRACT

Systems and methods related to a cryptocurrency system that enables transactions to be performed by transferring digital assets corresponding to amounts between appropriate entities are described. The cryptocurrency system includes a digital assets service provider computer that can host digital asset accounts associated with consumers and resource providers at which digital assets can be received. Consumers can be unbanked and use their digital asset account to perform cashless transactions. In one exemplary transaction, a consumer can receive change for the transaction as a digital asset that is assigned to their digital asset account. In another exemplary transaction, the consumer can use digital assets assigned to their digital asset account to pay for the transaction. Transfers of digital assets between accounts is managed by a ledger of transactions, which may be in the form of a block chain that cryptographically secures data that is stores.

### CROSS-REFERENCE TO RELATED APPLICATIONS

None.

### BACKGROUND

Conducting transactions using cash brings about several issues. For example, cash transactions are cumbersome for the involved entities. For consumers, it is a hassle to have to constantly carry around cash, as well as provide appropriate amounts of cash during transactions. Further, if consumers are not able to provide exact amounts of cash to pay for a transaction, they receive an amount of change (e.g., coins) from a resource provider. This physical change adds to the cash that the user carries around. In fact, the physical change that is carried by the user tends to accumulate because it is often difficult to rid of this change by using it in future transactions. Similarly, cash transactions are also a hassle for resource providers because they have to manage cash in their cash registers. For example, resource providers must ensure that their cash registers hold a sufficient amount of cash, as well as a sufficient variety of types of bills and coins, to provide change for transactions to consumers. Additionally, since it can take a longer time to conduct cash transactions when it is necessary to provide physical change to consumers, the rate at which resource providers can perform transactions is reduced. Thus, performing cash transactions can lower the efficiency at which transactions are performed by resource providers. Hence, it is desirable to not have to rely on cash for transactions.

Embodiments of the present invention address these and other problems, individually and collectively.

### BRIEF SUMMARY

One embodiments of the invention is related to a method related to transactions using digital assets. The method may comprise receiving, by a service provider computer a request for a digital asset corresponding to an amount owed to a consumer for a transaction conducted between the consumer and a resource provider associated with a resource provider computer. The method may further comprise generating, by the service provider computer, the digital asset corresponding to the amount and determining, by the service provider computer, a digital asset identifier associated with the digital asset, wherein the digital asset identifier is eventually provided to a computing device of the consumer. The method may further comprise receiving, by the service provider computer, the digital asset identifier from the computing device of the consumer. The method may further comprise sending, by the service provider computer to a financial institution computer associated with the resource provider, a request to update an unalterable electronic ledger of transactions managed by the financial institution computer. The financial institution computer may update the unalterable electronic ledger of transactions to indicate the transfer of the digital asset from a digital asset account of the resource provider to a digital asset account of the consumer. In some embodiments, the transaction is a first transaction, the resource provider is a first resource provider, the resource provider computer is a first resource provider computer, and the financial institution computer is a first financial institution computer.

In some embodiments, a fast settlement process may be performed for the first transaction in real-time. In this case, the amount associated with the digital asset is available for use by the consumer in real-time.

The method may further comprise receiving, by the service provider computer from the computing device of the consumer, a request to pay for a second transaction using the digital asset, where the second transaction is conducted between the consumer and a second resource provider associated with a second resource provider computer. The method may further comprise generating, by the service provider computer, a token associated with the digital asset and sending, by the service provider computer, the token to the computing device. The method may further comprise sending, by the service provider computer to a second financial institution computer associated with the second resource provider, a request to update an unalterable electronic ledger of transactions managed by the second financial institution computer. The second financial institution computer may update the unalterable electronic ledger of transactions to indicate the transfer of the digital asset from the digital asset account of the consumer to a digital asset account of the second resource provider.

In some embodiments, the first financial institution computer, the second financial institution computer, and the service provider computer each manage an unalterable electronic ledger of transactions that stores information related to transactions performed using digital assets.

In some embodiments, the method may further comprise enabling the consumer to withdraw cash using their digital asset account. For example, The method may further comprise receiving, by the service provider computer from the computing device of the consumer, a selection of a third financial institution computer to manage a total amount associated with digital assets corresponding to the digital asset account of the consumer. The method may further comprise allowing, by the service provider computer, the selected third financial institution computer to aggregate the total amount associated with the digital asset account of the consumer.

Another embodiment of the invention is related to a method. The method may comprise receiving, by a service provider computer, a prepaid load request corresponding to an amount owed to a consumer for a transaction conducted between the consumer and a resource provider associated with a resource provider computer, wherein the prepaid load request is generated by the resource provider computer. The method may further comprise generating, by the service provider computer, a digital asset corresponding to the amount. The method may further comprise sending, by the service provider computer to a financial institution computer associated with the resource provider, a request to update an unalterable electronic ledger of transactions managed by the financial institution computer. The financial institution computer may update the unalterable electronic ledger of transactions to indicate the transfer of the digital asset to a digital asset account of the consumer. The method may further comprise sending, by the service provider computer, a prepaid load response indicating that the amount has been transferred.

Another embodiment of invention is directed to a service provider computer comprising: a processor and a computer readable medium coupled to the processor, the computer readable medium comprising code, executable by the processor to implement methods described herein.

Another embodiment of invention is directed to a computing device comprising: a processor and a computer readable medium coupled to the processor, the computer readable medium comprising code, executable by the processor to implement methods described herein.

These and other embodiments of the invention are described in further detail below.

### BRIEF DESCRIPTION OF THE DRAWINGS

FIG. 1 shows a block diagram showing various elements of a digital assets service system according to embodiments of the present invention.

FIG. 2 shows an exemplary mapping and flow of digital assets according to embodiments of the present invention.

FIG. 3 shows a digital assets service provider computer hosting digital asset accounts and digital asset management services according to embodiments of the present invention.

FIG. 4 shows an exemplary system according to embodiments of the present invention.

FIG. 5 shows a system with a detailed flow diagram of a transaction in which a consumer receives a digital asset for change according to embodiments of the present invention.

FIG. 6 shows a system with a detailed flow diagram of a transaction in which a consumer uses their digital asset account to pay for the transaction according to embodiments of the present invention.

FIG. 7 shows a system in which consumers can withdraw cash associated with their digital asset accounts according to embodiments of the invention.

FIG. 8 shows a flow diagram of another method of performing a transaction in which a consumer receives a digital asset for change according to embodiments of the present invention.

FIG. 9 shows a flow diagram of a fast settlement process according to embodiments of the invention.

FIG. 10 shows a number of entries in the form a block chain according to embodiments of the invention.

Prior to discussing embodiments of the invention, descriptions of some terms may be helpful in providing a better understanding of the invention.

“Digital currency” may refer to units of value that may be used as a form of payment for transactions, including financial transactions. Digital currency may be currency that is electronically generated by and stored within a user computing device. Digital currency may be purchased using conventional forms of currency (e.g., fiat currency) and generated with a specific value. Typically, the digital currency may not have a physical form of tender but may be accessible through a user computing device (e.g., mobile device) using a software application such as a digital wallet or mobile application. A type of digital currency may be cryptocurrency, which utilizes cryptographic methods for verification.

A “digital asset” may refer to digital content associated with a value. In some cases, the digital asset may also indicate a right to use the value and other attributes associated with the digital asset. For example, a digital asset may be data that indicates a digital currency value, such as a cryptocurrency value. The digital asset may also indicate a plurality of digital asset attributes, such as a bank identification number (BIN) identifier, a digital asset identifier, a timestamp, an acquirer public key, a resource provider identifier, and resource provider location. In other embodiments, the digital asset may correspond to other non-currency values, such as access privileges data (e.g., number of authorized usages) and time limit data.

A “cryptocurrency payment network” may refer to one or more server computers that function to operate and maintain a cryptocurrency system. The cryptocurrency payment network may function to facilitate the generation/issuance and distribution of digital currency between devices within the cryptocurrency payment network. The cryptocurrency payment network may also function to enable the performance of transactions between devices for the transfer or goods/services and/or the transfer of funds. The cryptocurrency payment network may operate nodes that manage a ledger of transactions.

A “ledger of transactions” may refer to a compilation of data from previous transactions. The ledger of transactions may be a database or other comparable file structure that may be configured to store data from all previous transactions performed using a digital currency, including the date and time of the transaction, the transaction amount, and identification information for the participants of the transaction (e.g., the sender and the receiver of the transaction amount). In some embodiments, the ledger of transactions may be in the form of an electronic ledger (e.g., block chain) in which data already stored in the electronic ledger is unalterable. In some embodiments, each node within a cryptocurrency payment network may store their own copy of the ledger of transactions. In other embodiments, only some nodes may store their own copy of the ledger of transactions.

An “issuer node” may be a device or module that enables management of the creation and issuance of digital assets. In some embodiments, the issuer node may be operated by a financial institution computer corresponding to a resource provider, which may utilize the issuer node to generate a digital asset.

A “manager node” may be a device or module that enables management of digital assets assigned to and utilized by consumers. In some embodiments, the manager node may be operated by a financial institution computer, which may submit data to the manager node to update ledgers of transactions in the cryptocurrency payment network.

A “digital signature” may refer to an electronic signature for a message. In some embodiments, the digital signature may be used to validate the authenticity of a transaction message sent within a cryptocurrency payment network. A digital signature may be a unique value generated from a message and a private key using an encrypting algorithm. In some embodiments, a verification algorithm using a public key may be used to verify the signature. The digital signature may be a numeric value, an alphanumeric value, or any other type of data including a graphical representation.

A “key” may refer to a piece of data or information used for an algorithm. A key may be a unique piece of data and is typically part of a key pair where a first key may be used to encrypt a message, while a second key may be used to decrypt the encrypted message. The key may be a numeric or alphanumeric value and may be generated using an algorithm. A management system server computer in a cryptocurrency payment network may generate and assign a unique key pair for each node in the cryptocurrency payment network.

A “key pair” may include a pair of encryption keys, such as a public key and a corresponding private key. The key pair may be used by nodes and/or payment entities to conduct transactions in the cryptocurrency payment network. The key pair may be generated by a server computer associated with the cryptocurrency payment network or may be generated by a financial institution server computer for a payment entity when an account with the financial institution server computer is created. The public key may be distributed throughout the cryptocurrency payment network in order to allow for authentication of payment transaction messages signed using the corresponding private key.

A “financial institution server computer” may refer to a computer associated with a financial institution (e.g., bank). Examples of financial institution server computers may include an access device, terminal, or a web server computer hosting a financial institution server Internet website. The financial institution server computer may be in any suitable form. Additional examples of financial institution server computers include any device capable of accessing the Internet, such as a personal computer, cellular or wireless phones, personal digital assistants (PDAs), tablet PCs, and handheld specialized readers.

A “resource providing entity” may be an entity that may make resources available to a user. A resource providing entity may also be known as a resource provider. Examples of resource providing entities include distributors, merchants, vendors, suppliers, owners, traders, and the like. In some embodiments, such entities may be a single individual, small groups of individuals, or larger groups of individuals (e.g., companies). Resource providing entities may be associated with one or more physical locations (e.g., supermarkets, malls, stores, etc.) and online platforms (e.g., e-commerce websites, online companies, etc.). At the physical locations, the resource providing entity may host an access device. In some embodiments, resource providing entities may make available physical items (e.g., goods, products, appliances, etc.) to the user. In other embodiments, resource providing entities may make available digital resources (e.g., electronic documents, electronic files, etc.) or time (e.g., rental time, use time, etc.) to the user. In other embodiments, resource providing entities may manage access to certain resources by the user.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

### DETAILED DESCRIPTION

Embodiments of the present invention are directed to a cryptocurrency system that enables transactions to be performed by transferring digital assets corresponding to cryptocurrency amounts to appropriate entities. The cryptocurrency system comprises a digital assets service provider computer that can host digital asset accounts associated with each consumer, so that each consumer may view the total amount of cryptocurrency corresponding to their digital assets through an application on their computing device. In addition, the digital assets service provider computer can host digital asset accounts associated with resource providers (e.g., merchants) with which the consumers conduct transactions.

The digital assets can be used in various transactions. When a consumer conducts a transaction with a resource provider, the resource provider may provide change to the consumer for the transaction by transferring a digital asset corresponding to the change amount from their digital asset account to the consumer's digital asset account. In another transaction conducted between a consumer and a resource provider computer, the consumer may pay for the transaction using their digital asset account by transferring digital assets corresponding to the transaction amount from their digital asset account to the resource provider's digital asset account.

The digital assets service provider computer may be configured to manage information related to transactions performed involving digital assets. For example, the cryptocurrency system may store a ledger of transactions over a network that records transaction data related to all transactions performed by consumers under the cryptocurrency system. The ledger of transactions may be updated each time a new transaction is conducted and the data stored in the ledger may serve as proof that digital assets were assigned to a certain consumer's digital asset account.

Embodiments of the invention provide advantages. For example, embodiments of the invention enable consumers such as unbanked consumers that do not have a relationship with a financial institution (e.g., bank) to perform cashless transactions in a secure manner. The use of cryptographic techniques to manage the ledger of transactions enables a secure system for transferring digital assets between entities since the recorded data is unalterable. Further, embodiments of the invention forgo the need for consumers and resource providers to manage change for transactions, which can be cumbersome.

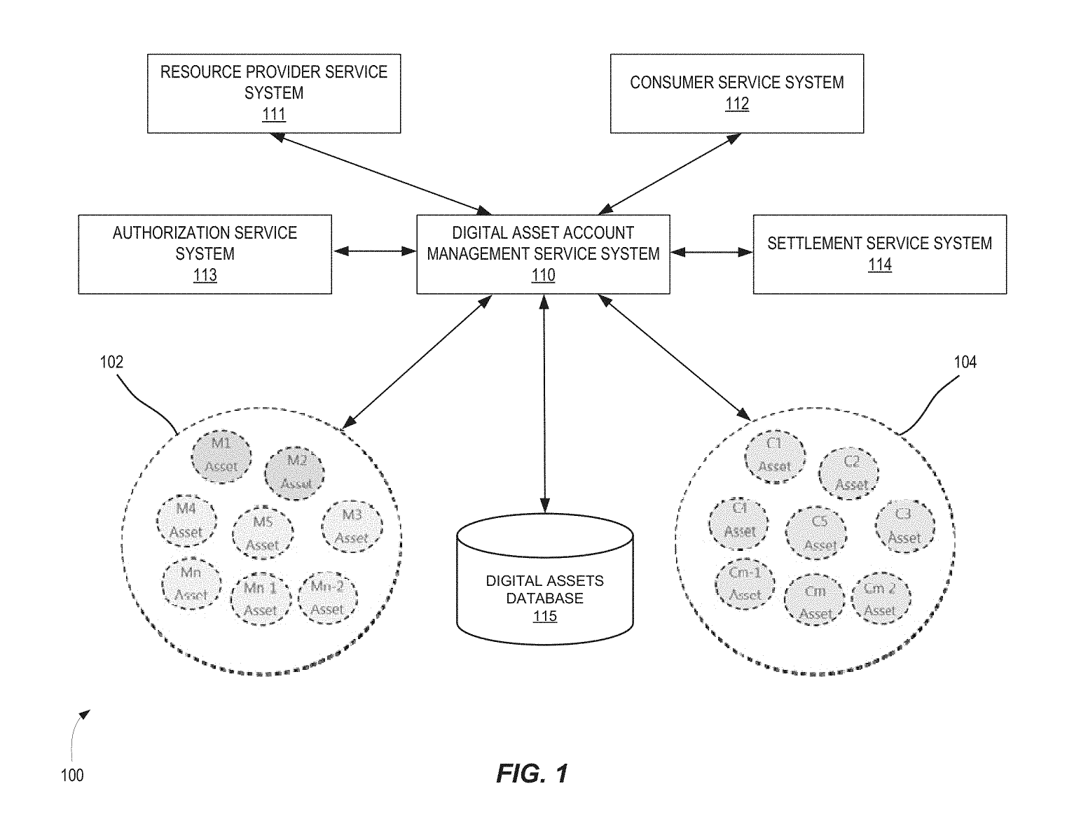

FIG. 1 shows a block diagram showing various elements of a digital assets service system 100 according to embodiments of the present invention. Digital assets service system 100 includes digital asset account management service system 110, resource provider service system 111, consumer service system 112, authorization service system 113, and settlement service system 114. The digital asset account management service system 110 can enable management of an issuer node 102, a manager node 104, and a digital assets database 115. Each of these service systems may be run on a single computer or multiple systems and computers that may be in operative communication with each other via any suitable communication medium (including the Internet), using any suitable communications protocol.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. Further details related to the components shown in FIG. 1 are described with respect to other figures described herein.

Digital asset account management service system 110 enables management of digital assets corresponding to digital asset accounts hosted by digital assets service system 100. Digital asset account management service system 110 may provide services such as mapping digital assets to real cryptocurrency amounts, allocating digital assets to consumer and resource provider accounts, and managing unclaimed digital assets. To provide these services, digital asset account management service system 110 may retrieve or update information in one or more of issuer node 102, manager node 104, and digital assets database 115.

Issuer node 102 may comprise one or more computers that manage information related to the creation and distribution of digital assets to various entities. Issuer node 102 may generate a digital asset corresponding to a certain amount upon request and record information related to the creation of the digital asset and issuance of the digital asset to an entity (e.g., consumer) for a transaction. Issuer node 102 may manage the information by recording relevant data in a ledger of transactions. In some embodiments, the ledger of transactions may be in the form of a block chain where each new block in the block chain references previous blocks (e.g., hash of previous block) such that any tampering of data stored in these previous blocks cannot go undetected.

Manager node 104 manages information related to digital assets associated with consumers. For example, a resource provider may assign a digital asset associated with a certain cryptocurrency value owed to a consumer. The consumer may claim the digital asset so that they can use the cryptocurrency value in future transactions. Manager node 104 may then record that the digital asset is now owned by the consumer. Manager node 104 may also manage cryptocurrency utilized by the consumer in various transactions. For example, after the consumer conducts a transaction using their digital asset account, manager node 104 may record information related to the transaction (e.g., time performed, transaction amount, participating entities, etc.). Manager node 104 may record the information in a ledger of transactions. In some embodiments, the ledger of transactions may be in the form of a block chain where each new block in the block chain references previous blocks (e.g., hash of previous block) such that any tampering of data stored in these previous blocks cannot go undetected.

Digital assets database 115 stores any information related to digital assets. For example, digital assets database 115 may store any number of digital asset attributes (e.g., amount, currency, timestamp, merchant ID, merchant location, digital asset identifier, etc.) for each of a plurality of digital assets. In some embodiments, digital assets database 115 may store digital assets identifiers corresponding to digital assets that have not yet been claimed by a consumer or resource provider. Any number of other digital attributes (e.g., amount) associated with the digital assets corresponding to the digital asset identifiers may be stored in association with the digital asset identifiers. This enables relevant digital attributes to be retrievable based on a query including a digital asset identifier to digital assets database 115. Digital asset attributes associated with a digital asset may be persisted in digital assets database 115 until the digital asset is claimed.

Digital assets database 115 may also store tokens to be utilized for transactions. A token may be an identifier (e.g., string of character or scannable image) that is associated with a set of digital assets. The token may be used to pay for transactions up to the total amount corresponding to the associated set of digital assets. In some embodiments, digital assets database 115 may store a token until it is redeemed by a resource provider computer. Digital assets database 115 may store tokens and associated information in a separate data table as that storing digital attributes indexed by digital asset identifiers as described above.

Digital assets database 115 may include any hardware, software, firmware, or combination of the preceding for storing and facilitating the retrieval of information. In addition, digital assets database 115 may use any of a variety of data structures, arrangements, and compilations to store and facilitate the retrieval of information.

Resource provider service system 111 enables resource providers to use services provided by digital assets service system 100. Resource provider service system 111 may enable resource providers the ability to enroll with and create an account with the digital assets service system 100. Resource provider service system 111 may provide an application for resource providers that enables them to view, update, and manage information associated with their account. Resource providers may use the application to instruct transfer of digital assets from their account to other accounts, as well as claim digital assets to be added to their account.

Consumer service system 112 enables consumers to use services provided by digital assets service system 100. Consumer service system 112 may enable consumers the ability to enroll with and create an account with digital assets service system 100. Consumer service system 112 may provide an application for a consumer that enables them to view, update, and manage information associated with their account. In some cases, the application may be a digital wallet that can run on a consumer's device. Consumers may use the application to the application to instruct transfer of digital assets from their account to other accounts, as well as claim digital assets to be added to their account.

Authorization service system 113 and settlement service system 114 may enable authorization, clearing, and settling for transactions conducted using digital assets service system 100. In some embodiments, authorization and clearing processes may be performed in real time, while settlement processes may be conducted at the end of the day during which real cryptocurrency value is transferred. In other embodiments, certain settlement processes may be conducted in real-time in order to enable consumers to utilize cryptocurrency corresponding to digital assets immediately upon claiming the digital assets.

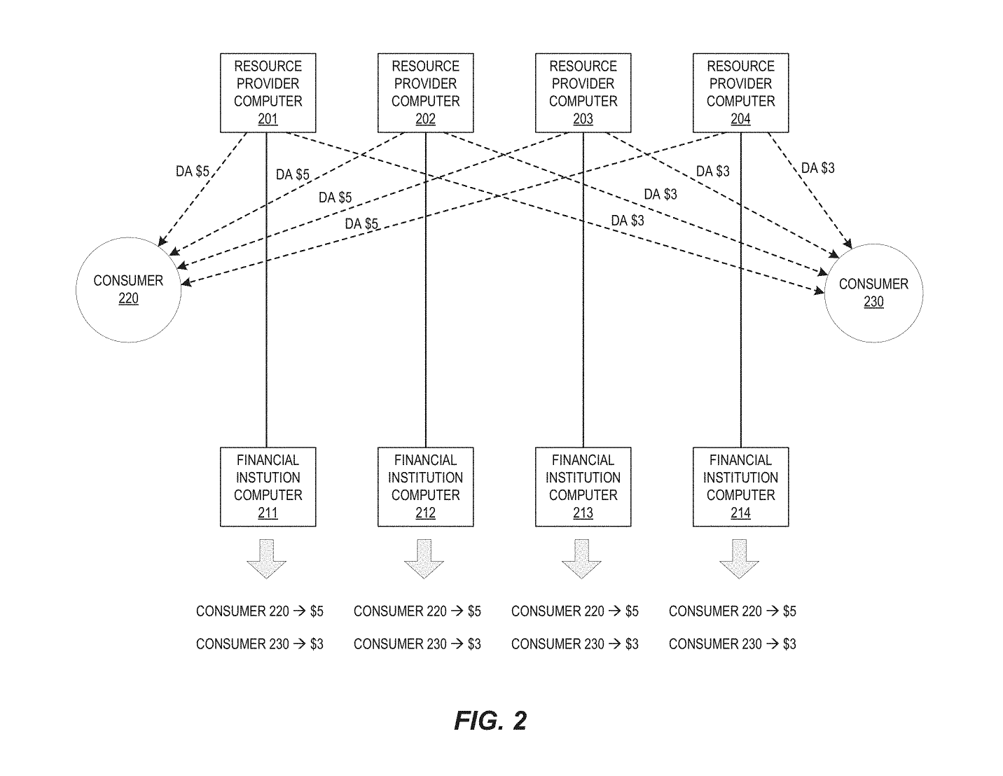

FIG. 2 shows an exemplary mapping and flow of digital assets according to embodiments of the present invention. FIG. 2 includes resource provider computer 201 associated with financial institution computer 211, resource provider computer 202 associated with financial institution computer 212, resource provider computer 203 associated with financial institution computer 213, and resource provider computer 204 associated with financial institution computer 214. Each resource provider computer may be associated with a financial institution computer that manages its money. In some embodiments, each of resource provider computer 201-204 may be a merchant computer operated by a merchant, while its corresponding financial institution computer 211-214 may be an acquirer computer operated by the merchant's acquirer or the merchant's bank.

While FIG. 2 shows a limited number of resource provider computers and financial institution computers for simplicity, it is understood that there may be any suitable number of resource provider computers and financial institution computers according to embodiments of the invention. It is understood that resource provider is used interchangeably with resource provider computer and financial institution is used interchangeably with financial institution computer. A digital asset is shown in FIG. 2 as “DA” for brevity.

In the exemplary case shown in FIG. 2, consumer 220 and consumer 230 have conducted a transaction involving digital assets at each resource provider computer. Each transaction resulted in an amount to be returned as change to each consumer. For example, resource provider computer 201 owes $5 to consumer 220 for a transaction conducted with consumer 220 and $3 to consumer 230 for a transaction conducted with consumer 230. Resource provider computer 201 may thus request that a digital asset corresponding to $5 (“DA $5”) be assigned to consumer 220 and a digital asset corresponding to $3 (“DA $3”) be assigned to consumer 230. Similarly, resource provider computer 202, resource provider computer 203, and resource provider computer 204 owe $5 to consumer 220 and $3 to consumer 230. Thus, resource provider computer 202, resource provider computer 203, and resource provider computer 204 may request that a digital asset corresponding to $5 (“DA $5”) be assigned to consumer 220 and a digital asset corresponding to $3 (“DA $3”) be assigned to consumer 230.

The assignment of a digital asset may be performed by recording data in ledgers of transactions that indicate the owner of the digital asset and the amount to which the digital asset corresponds. This process is described in further detail herein. In addition to recording data indicating the assignment of the digital asset, actual amounts of money corresponding to the assigned digital assets are managed by the financial institution computers associated with the resource provider computers.

Each financial institution computer 211, 212, 213, 214 may hold or manage money associated with the amounts owned by its corresponding resource provider computer to consumers. For example, since resource provider computer 201 requested the assignment of a digital asset associated with $5 to consumer 220 and a digital asset associated with $3 to consumer 230, financial institution computer 211 may hold $5 for consumer 220 and $3 for consumer 230. Similarly, financial institution computer 212, financial institution computer 213, and financial institution computer 214 may hold $5 for consumer 220 and $3 for consumer 230 with respect to transactions associated with resource provider computer 202, resource provider computer 203, and resource provider computer 204, respectively. While the same amounts are owed to the consumers by the resource provider computers in FIG. 2 for simplicity, it is understood that the amount owed can differ in other cases.

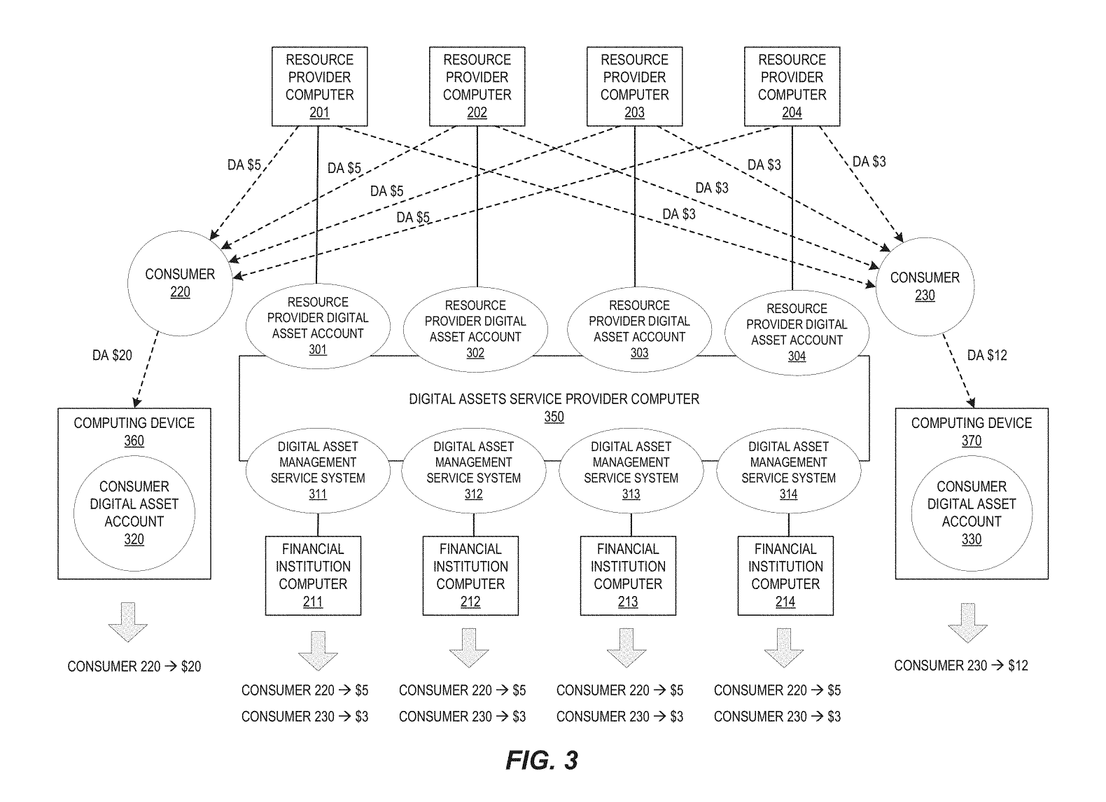

A digital assets service provider computer may enable the resource providers and the consumers to manage their digital assets. The digital assets service provider computer may provide services such as those described for digital assets service system 100 with respect to FIG. 1. For example, the digital assets service provider computer may host digital asset accounts for resource providers and consumers. In some embodiments, the digital assets service provider computer may also host applications through which the resource provider computers and consumers may view information related to their digital asset accounts, as well as use their digital assets to conduct transactions. Such features are described in further detail with respect to FIG. 3.

FIG. 3 shows a digital assets service provider computer 350 hosting digital asset accounts and digital asset management services according to embodiments of the present invention. FIG. 3 includes elements of FIG. 2. In addition, FIG. 3 includes computing devices 360 and 370, consumer digital asset accounts 320 and 330, and resource provider digital asset accounts 301, 302, 303, and 304, and digital asset management services systems 311, 312, 313, and 314.

Each consumer may have a digital asset account managed by digital assets service provider computer 350. For example, consumer 220 may be associated with consumer digital asset account 320 that includes information related to the digital assets assigned to consumer 220 and consumer 230 may be associated with consumer digital asset account 330 that includes information related to the digital assets assigned to consumer 230. In this exemplary case, consumer digital asset account 320 may indicate that a total amount of $20 is assigned to consumer 220 from resource provider computers 201, 202, 203, 204, and consumer digital asset account 330 may indicate that a total amount of $12 is assigned to consumer 230 from resource provider computers 201, 202, 203, 204.

In some embodiments, each consumer may access their consumer digital asset account through an application running on their computing device (e.g., mobile device). For example, consumer 220 may access consumer digital asset account 320 through an application running on computing device 360 and consumer 230 may access consumer digital asset account 330 through an application running on computing device 370. In some cases, the application may be a digital wallet that enables, among other actions, a consumer to load digital assets received from resource providers into their account, as well as pay resource providers using digital assets in their account. The consumer may also use the digital wallet to view the total value of digital assets associated with their account. In some cases, the digital wallet may be configured so that the consumer may not be able to view which entities issued specific digital assets. However, this information may be stored in the backend and used by the digital wallet to process transactions. After initially downloading the application, the consumer may be requested to provide a user identifier (e.g., email address, phone number, etc.), name, and password. In some cases, user anonymity may be supported by user of an alias identifier or other substitute information.

Each resource provider computer may also have a digital assets account managed by digital assets service provider computer 350. For example, resource provider digital asset accounts 301, 302, 303, and 304 may correspond to resource provider computers 201, 202, 203, and 204, respectively. Each resource provider digital asset account may manage information related to the digital assets assigned to its corresponding resource provider computer.

In some embodiments, each resource provider computer may access their resource provider digital asset account through an application. In some cases, the application may run on the resource provider computer or other electronic device in communication with the resource provider computer (e.g., mobile point-of-sale device). When performing transactions involving digital assets, the resource provider computers may use the application to distribute digital assets corresponding to certain amounts to consumers. After initially downloading the application, a resource provider computer may be requested to provide a resource provider name, a resource provider address, and resource provider Account Clearing House (ACH) account information (e.g., account number, routing number, etc.). In some cases, onboarding of a resource provider may be performed through a financial institution network (e.g., acquirer network).

Digital assets service provider computer 350 also provides digital asset management services to the financial institution computers associated with the resource provider computers. As described above with respect to FIG. 2, each financial institution computer may hold money associated with digital assets that their corresponding resource providers transferred to consumers. To keep track of the transferred digital assets and corresponding amounts, the financial institution computers can use digital asset management services to record relevant information in a ledger of transactions.

In some embodiments, digital asset management services may enable the information to be recorded in a ledger of transactions using block chain technology. For example, digital asset management service system 311 may enable financial institution computer 211 to manage a block chain ledger storing information surrounding transactions involving digital assets (e.g., receiving entity, timestamp, amount, digital asset identifier, etc.) conducted by resource provider computer 201. Financial institution computer 211 may update the block chain ledger after each new transaction involving digital assets conducted by resource provider computer 201. In this exemplary case, financial institution computer 211 may use digital asset management service system 311 to add entries into the block chain ledger that indicate that resource provider computer 201 transferred a digital asset corresponding to $5 to consumer 220 and a digital asset corresponding to $3 to consumer 230. Hence, digital asset management service system 311 may enable storage of a mapping between digital assets distributed by resource provider computer 201 and the consumers to which the digital assets were transferred. Digital asset management service systems 312, 313, and 314, may provide similar services to financial institution computers 212, 213, and 214, respectively.

Embodiments of the invention enable consumers to conduct cashless transactions without having a direct relationship with any financial institutions. Since money received by consumers can be managed by multiple financial institution computers, the consumers do not need to have a card account with a financial institution and thus may be unbanked. By simply enrolling for the services provided by digital assets service provider computer 350, the consumer may create a digital asset account that can accumulate funds owed to the consumer by resource providers. The funds can then be used by the consumers for new transactions.

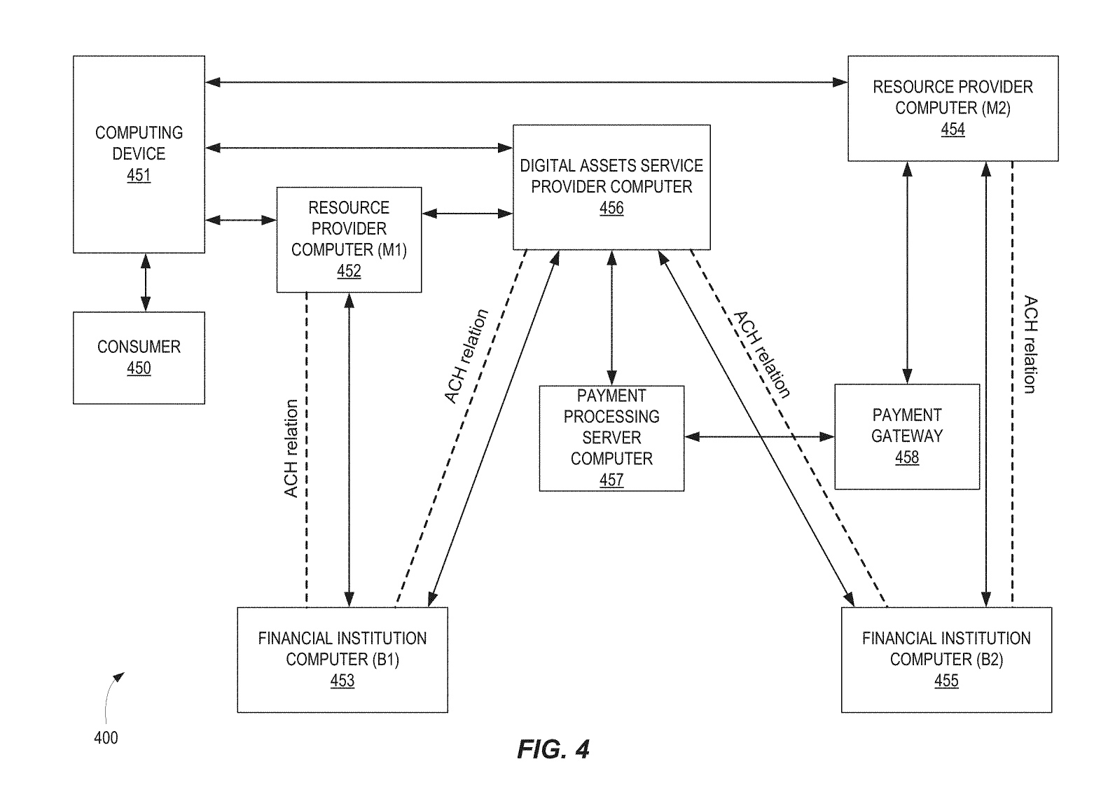

FIG. 4 shows an exemplary system 400 according to embodiments of the present invention. FIG. 4 includes a consumer 450 operating a computing device 451, resource provider computers 452 and 454, financial institution computers 453 and 455, a digital assets service provider computer 456, a payment processing server computer 457, and a payment gateway 458. Digital assets service provider computer 456 may provide services as described at least with respect to FIGS. 1 and 3. In some embodiments, digital assets service provider computer 456 may be operated by payment processing server computer 457. In other embodiments, digital assets service provider computer 456 may be operated by a separate entity.

Computing device 451 may be any suitable electronic device that can process and communicate information to other electronic devices. The computing device may include a processor, input devices, output devices, and a computer readable medium coupled to the processor, the computer readable medium comprising code, executable by the processor. The computing device may also each include an external communication interface for communicating with other computing devices (e.g., resource provider computers 452 and 454, digital assets service provider computer 456, etc.) over a network.

Computing device 451 may be in any suitable form. For example, computing device 451 can be hand-held and compact so that it can fit into a wallet and/or pocket (e.g., pocket-sized). Specific examples include cellular or mobile phones, tablet computers, desktop computers personal digital assistants (PDAs), pagers, portable computers, smart cards, and the like. Other examples include wearable devices (e.g., smart watches, glasses, fitness bands, ankle bracelets, rings, earrings, etc.) and automobiles with remote communication capabilities.

Resource provider computers 425 and 454 may be computers that handle processing for resource providers that conduct transactions. In some embodiments, resource provider computers may process information received from computing device 451 or by a mobile point-of-sale device into which consumer 450 provides information. Resource provider computers 425 and 454 may forward information to appropriate entities, such as digital assets service provider computer 456, financial institution computers 453 and 455, payment gateway 458, and payment processing server computer 457. In some cases, resource provider computers 425 and 454 may host online websites or applications through with consumer 450 can perform transactions.

Financial institution computers 453 and 455 may be computers that are associated with financial institutions (e.g., banks) that manage money. Financial institution computers 453 and 455 may be associated with resource provider computers 452 and 454, respectively. Financial institution computer 453 may be associated with a financial institution that holds money associated with digital assets transferred from the digital assets account of resource provider computer 452 to consumer digital assets accounts. Financial institution computer 455 may be associated with a financial institution that holds money associated with digital assets transferred from the digital assets account of resource provider computer 454 to consumer digital assets accounts.

Payment processing server computer 457 may include a server computer used for payment processing. In some embodiments, payment processing server computer 457 may be coupled to a database and may include any hardware, software, other logic, or combination of the preceding for servicing the requests from one or more client computers. Payment processing server computer 457 may comprise one or more computational apparatuses and may use any of a variety of computing structures, arrangements, and compilations for servicing the requests from one or more client computers. In some embodiments, payment processing server computer 457 may operate multiple server computers. In such embodiments, each server computer may be configured to process transaction for a given region or handles transactions of a specific type based on transaction data.

Payment processing server computer 457 may include data processing subsystems, networks, and operations used to support and deliver authorization services, exception file services, and clearing and settlement services. An exemplary payment processing server computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing server computer may use any suitable wired or wireless network, including the Internet.

Payment processing server computer 457 may process transaction-related messages (e.g., authorization request messages and authorization response messages) and determine the appropriate destination computer for the transaction-related messages. In some embodiments, the payment processing server computer may authorize transactions on behalf of an authorization computer. Payment processing server computer 457 may also handle and/or facilitate the clearing and settlement of financial transactions.

Payment gateway 548 may be a server computer that facilitates information from a payment portal to another processing entity, For example, payment gateway 548 may transfer information received from resource provider computer 454 to payment processing server computer 457. In some embodiments, payment gateway 548 may receive the information from an online website hosted by resource provider computer 454.

The exemplary system 400 that may be used for two exemplary transactions conducted by consumer 450. A first transaction may be conducted between consumer 450 and resource provider computer 452. A second transaction may be conducted between consumer 450 and resource provider computer 454. Consumer 450 and resource provider computers 452 and 454 may be enrolled with and have digital asset accounts with digital assets service provider computer 456. Both transactions may involve transfer of digital assets from one digital asset account to another digital asset account. The transfers of digital assets may be facilitated by digital assets service provider computer 456.

Clearing and settlement of the transactions may be enabled by a mapping of Automated Clearing House (ACH) accounts between the resource provider computers and digital assets service provider computer 456. For example, the ACH account of resource provider computer 452 may be mapped to the ACH account of digital assets service provider computer 456 by financial institution computer 453 and the ACH account of resource provider computer 454 may be mapped to the ACH account of digital assets service provider computer 456 by financial institution computer 455. In some embodiments, the ACH account of digital assets service provider computer 456 may be unique per resource provider.

Consumer 450 may pay for the first transaction using cash and request resource provider computer 452 for change for the transaction in the form of a digital asset. Consumer 450 may send the request using an application on computing device 451, which may communicate the request to digital assets service provider computer 456. Digital assets service provider computer 456 may generate a digital asset corresponding to the change amount and issue the digital asset to the digital asset account of consumer 450. Consumer 450 may claim the digital asset using the application on computing device 451. Digital assets service provider computer 456 may send a request to financial institution computer 453 to move the change amount from the ACH account of resource provider computer 452 to the ACH account of digital assets service provider computer 456. In some embodiments, the request may be sent in real time when consumer 450 conducts the first transaction to ensure that the amount is immediately available to consumer 450.

Consumer 450 may pay for the second transaction conducted with resource provider computer 454 using their digital asset account. Consumer 450 may use the application on computing device 451 to input a request for generation of a token corresponding to a transaction amount that can be used to pay for the second transaction. The request may be sent to digital assets service provider computer 456, which may generate the token corresponding to the transaction amount based on digital assets that are assigned to the digital asset account of consumer 450.

The token may be any suitable unique identifier that can be input by consumer 450 into computing device 451. In some embodiments, the token may be a string of alphanumeric characters that can be key-entered by consumer 450 into computing device 451. For example, the token may be a six-digit string of alphanumeric characters that consumer 450 may enter into an interface displayed by computing device 451. In other embodiments, the token may be in another form, such as a scannable image that can be scanned by consumer 450 using an application on computing device 451. For example, the token may be a QR code that can be scanned by consumer 450 using their application on computing device 451.

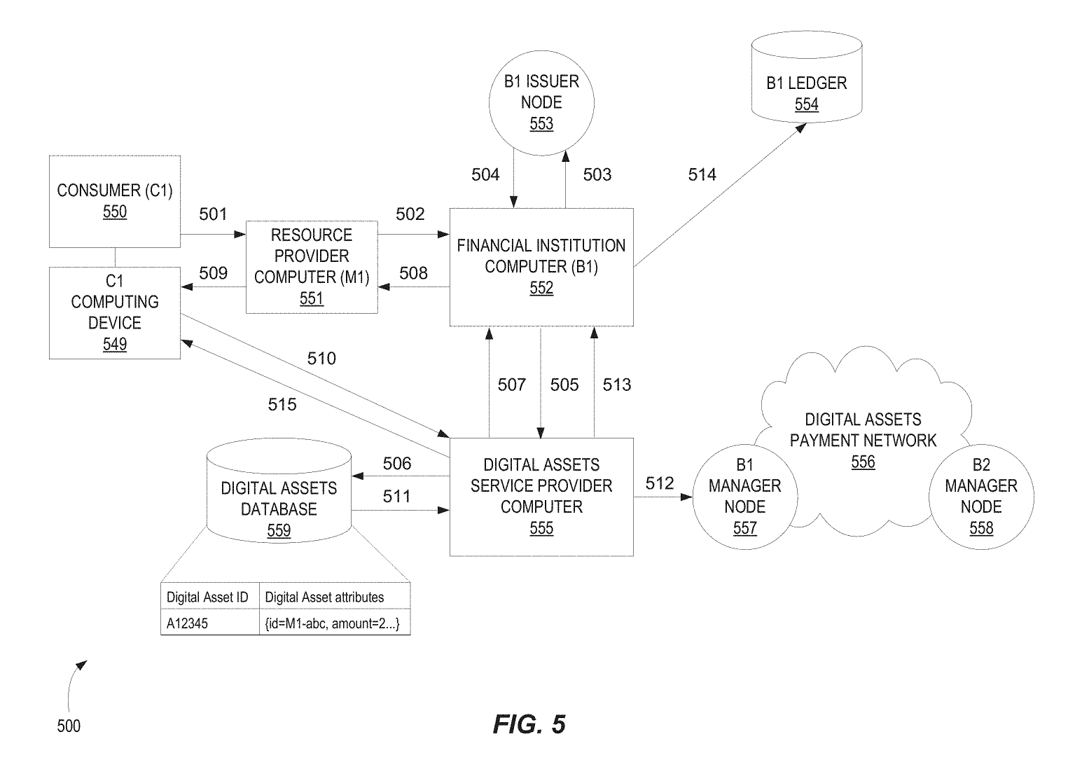

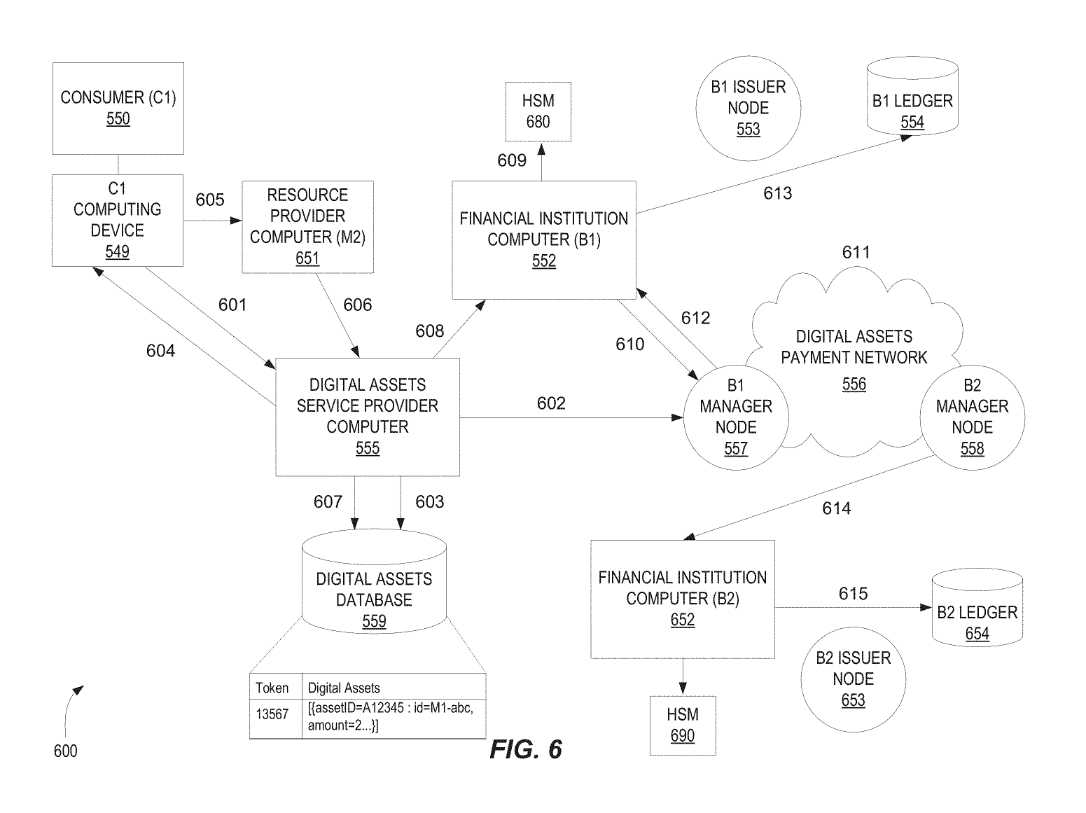

Consumer 450 may access the token through the application on computing device 451 and use the token to pay for the second transaction. In some cases, consumer 450 may enter the token into an online payment website hosted by resource provider computer 454. An authorization request for the second transaction may be processed by payment gateway 458 and payment processing server computer 457. At the end of the day, a settlement process can be performed in which digital assets service provider computer 456 sends a request to financial institution computer 455 to move the transaction amount from the ACH account of digital assets service provider computer 456 to the ACH account of resource provider computer 454. Further details of the exemplary two transactions are described with respect to at least FIGS. 5 and 6.

While two exemplary transaction are described in detail herein, embodiments are not so limited. For example, in other embodiments, the first transaction can be paid in a different manner than by cash and the transactions are not restricted to being in-person transaction or online transactions.

FIG. 5 shows a system with a detailed flow diagram 500 of a transaction in which a consumer receives a digital asset for change according to embodiments of the present invention. FIG. 5 includes a computing device 549 operated by a consumer 550, a resource provider computer 551 associated with a resource provider, a financial institution computer 552 associated with resource provider computer 551, an issuer node 553 and a ledger 554, a digital assets service provider computer 555, a digital assets payment network 556 (can also be known as cryptocurrency payment network), manager node 557, and a digital assets database 559. Functionality provided by issuer node 553 and manager nodes 557 and 558 may be provided by digital assets service provider computer 555. The financial institution computer 552 may be running a digital assets application hosted by digital assets service provider computer 555. The transaction may be conducted between consumer 550 and resource provider computer 551, in which consumer 550 pays for the transaction using cash and receives back change for the transaction in the form of a digital asset.

At step 501, consumer 550 pays the resource provider for the transaction. In an exemplary case, the transaction amount may be $8 and consumer 550 may pay $10 for the transaction. Thus, the resource provider may owe consumer 550 a change amount of $2. The resource provider may have an account with digital assets service provider computer 555 and can provide consumer 550 the option to receive change in the form of a digital asset.

Consumer 550 may choose to receive the change in the form of a digital asset. If consumer 550 has not installed a digital wallet for managing digital assets on their computing device 549, consumer 550 may download the digital wallet application hosted by digital assets service provider computer 555 and set up their digital wallet by providing enrollment information, such as a user identifier (e.g., email address, phone number, etc.), name, and a password. In some embodiments, a key pair corresponding to consumer 550 may be generated and stored by the digital wallet at this point.

Consumer 550 may then indicate to the resource provider that they would like to receive the change amount as a digital asset. In some embodiments, consumer 550 may interact with resource provider computer 551 to indicate that they would like to receive the change amount as a digital asset. For example, consumer 550 may activate buttons on an interface provided by resource provider computer 551 or send a message from computing device 549 to resource provider computer 551. In other cases, consumer 550 may verbally communicate the preference to an agent at the point-of-sale terminal that can then input the relevant information to resource provider computer 551.

At step 502, resource provider computer 551 sends a request for generation of a digital asset corresponding to the change amount to financial institution computer 552. Any communications received and sent by the financial institution computer 552 may be performed through a resource provider digital assets application operated by resource provider computer 551. A key pair may have been generated corresponding to resource provider computer 551 during initial set up of the resource provider digital assets application. In some embodiments, the request may be sent with the change amount, a timestamp corresponding to the transaction, a resource provider identifier, a resource provider location, and other information that can be used to generate the digital asset.

At step 503, financial institution computer 552 sends the request to issuer node 553, which generates the digital asset based on the request. In some embodiments, financial institution computer 552 may check that the resource provider has enough funds to provide the change amount prior to sending the request to generate the digital asset. If enough funds are available, issuer node 553 may generate the digital asset based on information sent with the request. The digital asset may comprise data attributes such as a BIN identifier, a digital asset identifier, an amount, a currency, a timestamp, an acquirer public key, a resource provider identifier, and a resource provider location. The digital asset identifier may be an identifier generated by issuer node 553 that uniquely identifies the digital asset. For example, the digital asset identifier may be a string of alphanumeric characters or a scannable image (e.g., QR code). An example of a digital asset identifier may include a transaction identifier. The amount may correspond to the change amount sent with the request. Issuer node 553 may send information related to the digital asset, such as certain digital asset attributes (e.g., amount, resource provider identifier) associated with the digital asset to financial institution computer 552.

At step 504, financial institution computer 552 receives the digital asset attributes associated with the digital asset. The received digital asset attributes includes the digital asset identifier that uniquely identifier the digital asset. In this exemplary case, the digital asset identifier may be a 6-digit alphanumeric string, such as “A12345.”

At step 505, financial institution computer 552 creates a request to store the digital attributes associated with the digital asset and sends the request to digital assets service provider computer 555.

At step 506, digital assets service provider computer 555 stores the digital asset attributes associated with the digital asset in digital assets database 659. In some embodiments, digital assets database 659 may store the digital asset attributes such that they are indexed by the digital asset identifier. However, digital assets database 659 may store the digital asset attributes in any suitable manner. In some embodiments, while not required, digital assets database 659 may store information in a queue so that the digital asset attributes are stored in an order relative to the time of generation of the corresponding digital asset. The information related to the digital asset may remain stored in digital assets database 559 until consumer 550 claims the corresponding digital asset.

At steps 507, 508, and 509, after the digital assets service provider computer 555 determines the digital asset identifier corresponding to the digital asset, the digital asset identifier may be sent from digital assets service provider computer 555 to computing device 549. In some embodiments, the digital asset identifier may be sent via financial institution computer 552 and resource provider computer 551. The digital asset identifier may be displayed by consumer 550 on their computing device 549 (e.g., as a string of characters or a scannable image). In some cases, steps 507, 508, and 509 may be performed prior to or in parallel with step 506.

At step 510, consumer 550 claims the digital asset by sending the received digital asset identifier associated with the digital asset to digital assets service provider computer 555. For example, consumer 550 may key-enter the digital asset identifier “A12345” into their digit wallet application on computing device 549. The digital wallet application may then send a message to digital assets service provider computer 555 indicating that consumer 550 wants to claim the digital asset associated with the entered digital asset identifier.

In other embodiments, consumer 550 may receive the digital asset identifier in another suitable format, such as a scannable image (e.g., QR code). In this case, consumer 550 may scan the digital asset identifier using their digital wallet, which may then send the digital asset identifier to digital assets service provider computer 555.

It is understood that consumer 550 may claim the digital asset at any suitable time after the generation of the digital asset. In some embodiments, consumer 550 may choose to claim the digital asset soon after the transaction, such as when consumer 550 is still at the resource provider location. In other embodiments, consumer 550 may choose to claim the digital asset at a later time.

At step 511, digital assets service provider computer 555 retrieves information related to the digital asset associated with the received digital asset identifier from digital assets database 559. Digital assets service provider computer 555 may send a query to digital assets database 559 for information associated with the digital asset identifier. If the query returns no information, digital assets database 559 may determine that the digital asset identifier is not valid and may send a notification indicating this to computing device 549. If the digital asset identifier is valid, the query may return the information (e.g., digital asset attributes) related to the digital asset stored in association with the digital asset identifier to digital assets service provider computer 555.

At step 512, digital assets service provider computer 555 communicates with manager node 557 and looks for the digital asset account associated with consumer 550. The digital asset account of consumer 550 may be identified by a consumer public address, which may be the a public key associated with consumer 550. If a digital asset account associated with consumer 550 does not yet exist, a digital assets service provider computer 555 may generate a digital asset account for consumer 550. The public key associated with consumer 550 may be retrieved from the digital wallet of consumer 550 and the public key may be bound to the digital asset account of consumer 550. This enables any digital assets that are issued to the public address associated with consumer 550 to be associated with the digital asset account of consumer 550.

Digital assets service provider computer 555 can send relevant information including that retrieved in step 511 to manager node 557 that indicates the transfer of the digital asset. In this case, the information can indicate at least the entity that requested generation of the digital asset (resource provider computer 551) and their public address (public key), the entity that received the digital asset (consumer 550) and their public address (public key), the digital asset identifier, and the amount corresponding to the digital asset. Exemplary information is shown below.

| Merchant | | Sender | Receiver | Digital | |
|---|---|---|---|---|---|
| ID | Consumer ID | Address | Address | Asset ID | Amount |
| M1-abc | C1-1234 | M1pubkey | C1pubkey | A12345 | $2.00 |

Digital assets service provider computer 555 may include a digital signature with the information to be sent to manager node 557. The digital signature may be generated by using the private key associated with resource provider computer 551, which distributed the digital asset. This can allow other entities (e.g., nodes) that may access the information to verify the transfer of the digital asset based on the digital signature. For example, the other entities can use the corresponding public key associated with resource provider computer 551 to verify the digital signature and verify that the information is valid. This verification can ensure that the digital asset is owned by consumer 550.

At step 513, digital assets service provider computer 555 requests financial institution computer 552 to issue the digital asset to the digital asset account of consumer 550. The request may indicate to update ledger 554 to indicate the transfer of the digital asset from the digital asset account of the resource provider associated with resource provider computer 551 to the digital asset account of consumer 550. Based on the request, financial institution computer 552 may initiate the process of updating ledger 554 to include the information received by manager node 557 in step 512.

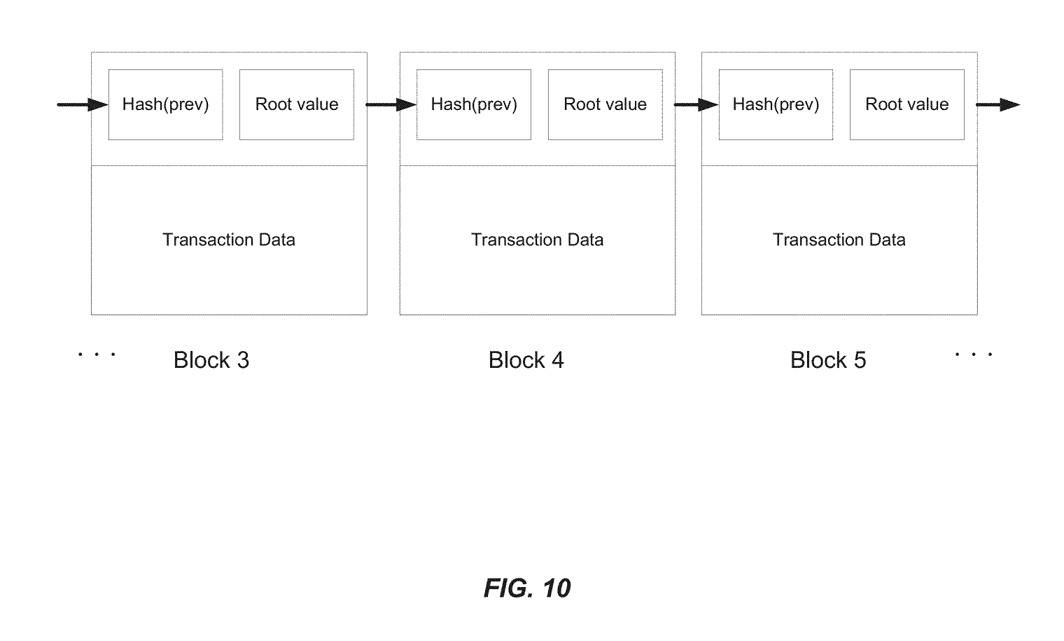

At step 514, financial institution computer 552 may send an instruction to update ledger 554. The ledger 554 may be in the form of a block chain that can be updated to include a new entry comprising the information received by manager node 557 above indicating the transfer of the digital asset. In addition, the new entry may also comprise a data header that includes information that makes the new entry unalterable without detection. For example, the data header may include a hash of the previous entry in ledger 554 and a root value of all past transactions. Since each entry in ledger 554 may be generated in a similar manner by including a data header storing information referencing its previous entry and previous transactions, no entry can be modified without affecting all following entries. This ensures that any tampering of information related to transactions, such as an attempt to reassign a digital asset to an inappropriate entity, will not go unnoticed. An exemplary number of entries in the form of a block chain as described above are shown in FIG. 10.

At step 515, digital assets service provider computer 555 pushes updated information to the digital wallet running on computing device 549 based on the completed transaction. The updated information may include an updated total value assigned to the digital asset account of consumer 550. The total value may be viewed by consumer 550 through an interface of the digital wallet. In this case, the updated total value can show an increase from its previous total value of $2 corresponding to the change amount received by consumer 550. In some embodiments, the updated information may also include updated digital asset configuration data, such as digital asset attributes associated with the digital asset that was assigned to consumer 550 for the transaction. The updated digital asset configuration data may be stored on the backend by the digital wallet, but may not be accessible to consumer 550 through the interface of the digital wallet.

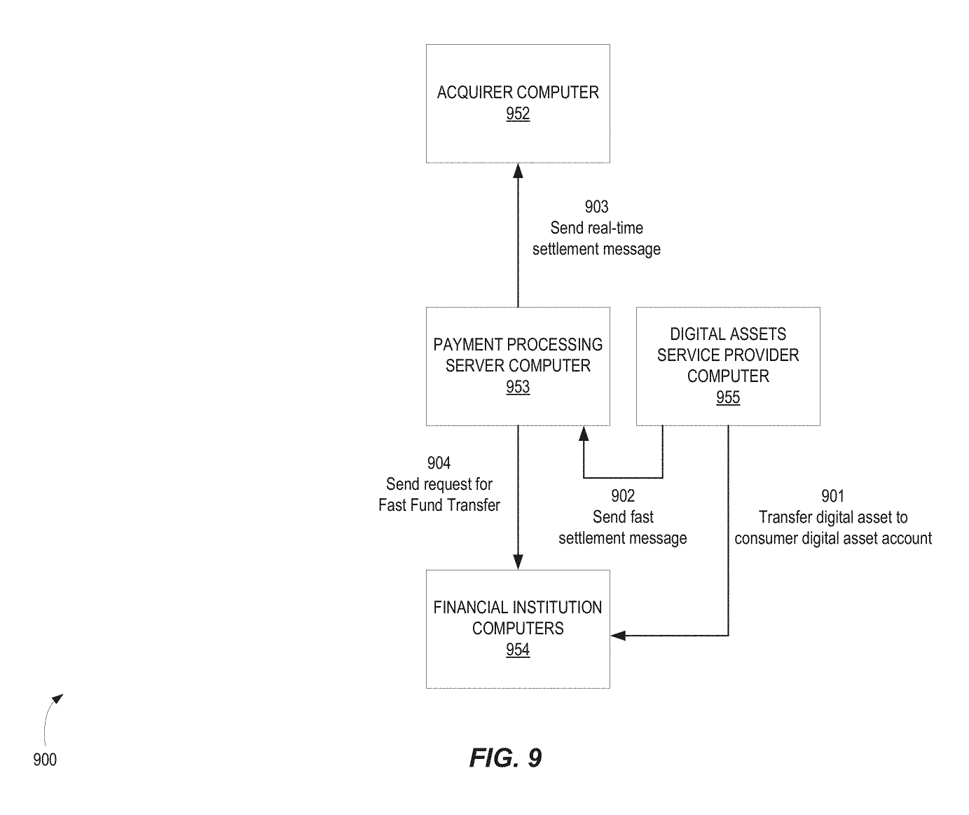

After the digital asset has been issued to consumer 550 and ledger 554 updated, a settlement process may be performed (not shown). The settlement process may be a “fast settlement,” in which the settlement request is sent during the transaction to ensure that the funds associated with the claimed digital asset are made available to consumer 550 in real-time. An exemplary fast settlement flow is described in further detail with respect to FIG. 9.

FIG. 6 shows a detailed flow diagram 600 of a transaction in which a consumer uses their digital asset account to pay for the transaction according to embodiments of the present invention. FIG. 6 includes some components of FIG. 5. FIG. 6 also includes a resource provider computer 651, hardware security modules (HSM) 680 and 690, a financial institution computer 652 associated with resource provider computer 651, an issuer node 653, and a ledger 654. Functionality provided by issuer node 653 and manager nodes 557 and 558 may be provided by digital assets service provider computer 555. The financial institution computer 652 may be running a digital assets application hosted by digital assets service provider computer 555. The transaction may be conducted between consumer 550 and resource provider computer 651, in which consumer 550 pays for the transaction using their digital asset account. The resource provider computer 651 may be a second resource provider computer or more specifically a second merchant computer.

In the exemplary case shown, the transaction described in FIG. 6 is performed after the transaction described in FIG. 5 is performed. For the description of FIG. 6, the transaction conducted in FIG. 5 may be referred to as the first transaction and the transaction conducted in FIG. 6 may be referred to as the second transaction or current transaction.

At step 601, consumer 550 initiates a transaction using computing device 549 with resource provider computer 651 and requests to pay for the transaction using their digital asset account. For example, consumer 550 may purchase some goods from resource provider computer 651 amounting to a total transaction amount of $2. Consumer 550 may use the digital wallet on their computing device 549 to request payment of the transaction amount their digital asset account. Consumer 650 may indicate the transaction amount of $2 using the digital wallet on their computing device 649.

Based on the entered transaction amount, the digital wallet may determine a set of digital assets corresponding to the digital asset account of consumer 650 that can be used to pay for the transaction. Since consumer 550 entered a transaction amount of $2, the digital wallet may determine a set of digital assets that amount to $2.

Any suitable algorithm may be used to determine the set of digital assets. For example, the digital wallet may initially determine whether any digital assets exist that correspond to the same amount as the requested transaction amount. If one or more of these digital assets exist, one may be chosen at random or based on a certain order (e.g., based on date created). If no such digital assets exist, the digital wallet may then determine the digital asset corresponding to the greatest amount that is less than the transaction amount, calculate the difference between the transaction amount and the amount corresponding to the determined digital asset, and recursively perform the search for the rest of the set of digital assets that can sum to the calculated difference. If no set of digital assets can be combined to generate the exact transaction amount, the value of a digital asset can be split as described in more detail below.

In this exemplary case depicted in FIG. 6, the digital wallet may determine the digital asset received by consumer 550 in the first transaction shown in FIG. 5 corresponding to an amount of $2 and can be used to pay for the current transaction. The digital wallet may retrieve the digital asset identifier associated with the determined digital asset, as well as account identification information of the issuing entity of the digital asset. The digital wallet may then send the digital asset identifier and account identification information to digital assets service provider computer 655.

At step 602, digital assets service provider computer 555 requests verification of balances in the digital asset account of consumer 550 based on the information received from the digital wallet. Digital assets service provider computer 555 may determine a manager node associated with the received account identification information. In this case, digital assets service provider computer 555 may determine that account identification information is associated with resource provider computer 551 (see FIG. 5), which corresponds to manager node 557. Based on information tracked by manager node 557 related to the first transaction performed between consumer 550 and resource provider computer 551, digital assets service provider computer 555 may request manager node 557 to verify that the digital asset associated with the received digital asset identifier is owned by consumer 550.

Manager node 557 may verify that the digital asset is properly assigned to the digital asset account of consumer 550. Manager node 557 may confirm that the information stored in a ledger of transactions indicates that the digital assets are owned by consumer 550. For example, manager node 557 may confirm that the digital asset is issued to the public address bound to the digital asset account of consumer 550. Upon confirmation, manager node 557 may notify digital assets service provider computer 555 that the digital asset is indeed owned by consumer 550. This allows digital assets service provider computer 555 to verify the balance associated with the digital asset account of consumer 550 and ensure that the balance is at least equal to the transaction amount of the current transaction.

At step 603, digital assets service provider computer 555 may generate a token corresponding to the transaction amount entered by consumer 650. The token may be a unique identifier (e.g., string of characters, scannable image, etc.). Digital assets service provider computer 555 may store the generated token in digital assets database 559. The token may be stored in association with the information related to the corresponding digital asset (e.g., digital asset identifier, amount, etc.). The token may be persisted until resource provider computer 651 redeems the token to add its value to their digital asset account.

At step 604, digital assets service provider computer 555 sends the token to computing device 549. Consumer 550 may view the received token using the digital wallet on computing device 549. In some embodiments, the token may be displayed as a string of characters or as a scannable image, such as a QR code.

At step 605, consumer 550 provides resource provider computer 651 with the token using computing device 549. In some embodiments, consumer 550 may key-enter the token or scan the token into resource provider computer 651 or a mobile-point-of-sale device in communication with resource provider computer 651. In other embodiments, consumer 550 may provide the token to an agent associated with resource provider computer 651 and the agent may enter the token into resource provider computer 651 or a mobile-point-of-sale device in communication with resource provider computer 651.

At step 606 and 607, resource provider computer 651 sends the token to digital assets service provider computer 655, which then verifies the received token. Digital assets service provider computer 555 may query digital assets database 559 with the token. If the query returns does not return any information, this can indicate that the token is not valid and cannot be used to pay for the current transaction. If the query returns information related to its corresponding digital asset, the token and its corresponding amount can be verified.

At step 608, digital assets service provider computer 555 requests financial institution computer 552 to initiate the process for recording data related to the current transaction. Specifically, digital assets service provider computer 555 may request financial institution computer 552 to build, sign, and submit the transaction data related to the current transaction that indicates the transfer of the digital asset from the digital asset account of the consumer to the digital asset account of resource provider computer 651.

At step 609, financial institution computer 552 builds and signs the transaction data to be recorded. In some embodiments, the transaction data can indicate at least the entity that initiated transfer of the digital asset (consumer 550) and their public address (public key), the entity that received the digital asset (resource provider computer 651) and their public address (public key), and the digital asset amount. Financial institution computer 552 may access HSM 680 to fetch a private key to use to digitally sign the transaction data. The private key may be associated with the digital asset that is being used to pay for the transaction. The private key may have been generated along with a corresponding public key when the digital asset was first generated by issuer node 553 and stored in HSM 680.

At steps 610 and 611, financial institution computer 552 submits the signed transaction data to manager node 557, which then triggers other manager nodes residing on digital assets payment network 656 to contact entities that maintain ledgers to update their ledgers with the new transaction data. By communicating the update to other nodes residing on digital assets payment network 656, this ensures that any entity maintaining a ledger can verify the authenticity of the transaction. For example, the digital signature included with the submitted transaction data can be verified by using the corresponding public key, which is made publicly available.

At step 612 and 613, manager node 557 sends an instruction to update their ledger to financial institution computer 552, which then updates ledger 554 with the new transaction data. Ledger 554 may be in the form of a block chain and the new transaction data can be stored in a new entry. The new entry may also comprise a data header that includes information that makes the new entry unalterable without detection. For example, the data header may include a hash of the previous entry in ledger 554 and a root value calculated based on all past transaction data. Since each entry in ledger 554 may be generated in a similar manner by including a data header storing information referencing its previous entry and previous transactions, no entry can be modified without affecting all following entries. This ensures that any tampering of information related to transactions, such as an attempt reassign a digital asset to an inappropriate entity, will not go unnoticed. An exemplary number of entries in the form of a block chain as described above are shown in FIG. 10.

At step 614 and 615, manager node 558 sends an instruction to update their ledger to financial institution computer 652, which then updates ledger 654 with the new transaction data. Similar to ledger 554, ledger 654 may be in the form of a block chain and the new transaction data can be stored in a new entry. The new entry may also comprise a data header that includes information that makes the new entry unalterable without detection. For example, the data header may include a hash of the previous entry in ledger 654 and a root value calculated based on all past transactions. Since each entry in ledger 654 may be generated in a similar manner by including a data header storing information referencing its previous entry and previous transactions, no entry can be modified without affecting all following entries. This ensures that any tampering of information related to transactions, such as an attempt reassign a digital asset to an inappropriate entity, will not go unnoticed. An exemplary number of entries in the form of a block chain as described above are shown in FIG. 10.

At the end of the day, a settlement process may be performed. Specifically, the settlement process may result in moving the transaction amount from the ACH account of digital assets service provider computer 555 to the ACH account of resource provider computer 651 with which consumer 550 performed the transaction.

It is understood that in other embodiments, the transaction amount for the second transaction may be a different amount than an amount corresponding to a single digital asset. For example, if the transaction amount is $9, a set of multiple digital assets associated with the digital asset account of consumer 550 that total to an amount of $9 may be aggregated. In one exemplary case, the set may include a digital asset corresponding to $1, another digital asset corresponding to $3, and another digital asset corresponding to $5. In this case, several of the steps described with respect to step 602 through step 615 may be performed for each of the digital assets, such as verification that the digital asset belongs to consumer 550 (step 602) and storage of the corresponding digital asset identifier and other digital asset attributes in digital assets database 559 in association with the generated token (step 603).

Further, additional information may be stored when updating a ledger of transactions during the second transaction. Namely, the information may indicate that multiple digital assets were used to pay for the transaction. For example, the information may include a list of digital asset identifiers associated with the multiple digital assets. Accordingly, this information can indicate that the digital assets corresponding to the digital asset identifiers and their corresponding full amounts were issued to the digital asset account of resource provider computer 651, which may be identified by the public address (public key) corresponding to resource provider computer 651.

In yet another embodiment, the exact transaction amount of the second transaction may not be able to be generated by summing amounts corresponding to multiple digital assets. For example, the transaction amount may be $8.50 and the only digital assets available in the digital asset account of consumer 550 may be a digital asset corresponding to $1, another digital asset corresponding to $3, and another digital asset corresponding to $5. In this case, one of the digital assets may be split such that a portion of the amount corresponding to the digital asset is issued to the digital asset account of resource provider computer 651 and the other remaining portion of the amount corresponding to the digital asset is issued to the digital asset account of consumer 550. For example, the digital asset corresponding to $1 may be split so that $0.50 is issued to the digital asset account of resource provider computer 651 and $0.50 is issued to the digital asset account of consumer 550.

To indicate this, additional information may be stored when updating a ledger of transactions during the second transaction. For example, the information may indicate the digital asset identifiers associated with the three digital assets that are being used to pay for the transaction, as well as the corresponding amounts to be issued to the digital asset account of resource provider computer 651 or the digital asset account of consumer 550. In this case, the information may indicate the digital asset identifier of the digital asset corresponding to an amount of $5, where the amount transferred is $5 and the digital asset identifier of the digital asset corresponding to an amount of $3, where the amount transferred is $3. The information may further indicate the digital asset identifier of the digital asset corresponding to an amount of $1, where the amount transferred to the digital asset account of resource provider computer 651 is $0.50 and the amount transferred (returned) to the digital asset account of consumer 550 is $0.50. The digital asset account of resource provider computer 651 can be identified by the public address (public key) corresponding to resource provider computer 651 and the digital asset account of consumer 550 can be identified by the public address (public key) corresponding to consumer 550.

Paying for a transaction using their digital asset account is a convenient process for consumer 550. As long as the digital asset account holds digital assets that correspond to a total amount of at least the transaction amount of a transaction, consumer 550 may pay for the transaction by simply sending a request to pay using their digital asset account through their computing device 549. The computations related to determination of the digital assets that are to be used to pay for transactions are run in the backend and do not rely on further input from consumer 550.

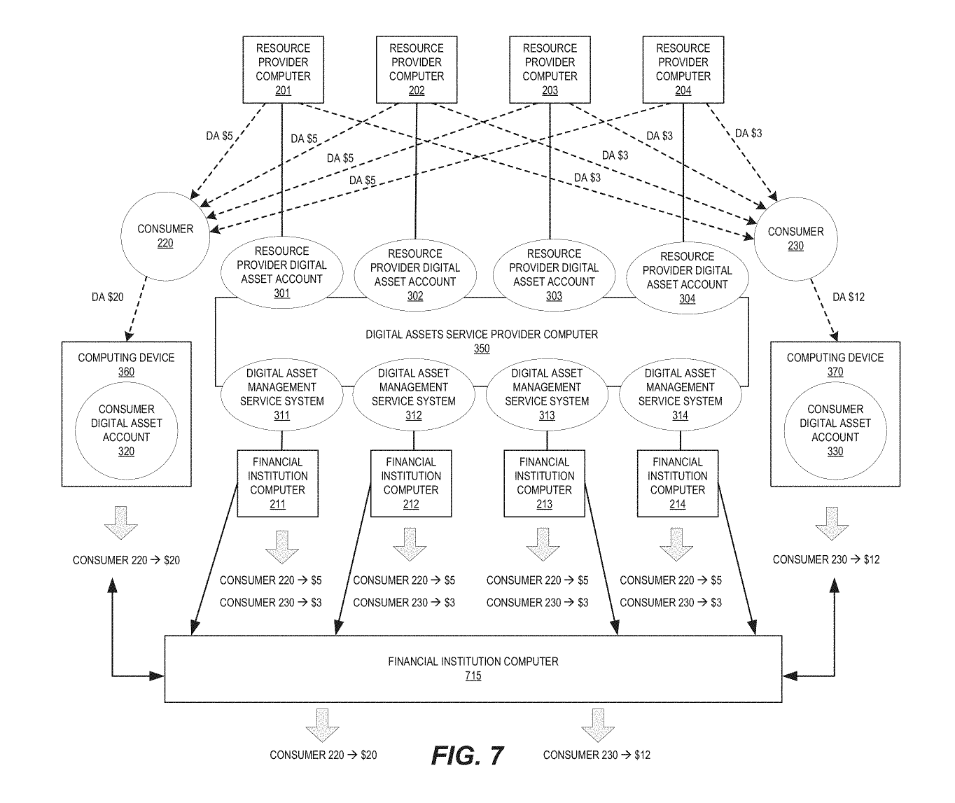

While the above described embodiments enable consumers without relationships with a financial institution (e.g., card issuer) to conduct cashless transactions, one potential feature that these unbanked consumers do not have is the ability to convert value in their digital asset account to cash. While these consumers can accumulate value in their digital asset account to use to pay transactions, they may want to be able to withdraw an amount of cash from their digital asset account. However, since the money associated with the consumer's digital asset account is held by multiple financial institutions, this poses challenges. A solution for enabling unbanked consumers with the ability to draw withdraw cash from their digital asset accounts is described with respect to FIG. 7.

FIG. 7 shows a system in which consumers can withdraw cash associated with their digital asset accounts according to embodiments of the invention. FIG. 7 includes components of FIG. 3 and a financial institution computer 715. While financial institution computer 211 through 214 holds money associated with the digital asset accounts of consumers as described with respect to FIG. 3, the money can be aggregated by a single entity when the consumers enroll with services provided by financial institution computer 715.

An exemplary enrollment process performed by consumer 220 is described. Consumer 220 may conduct the enrollment process using the digital wallet application associated with their consumer digital asset account 320 on computing device 360. Digital assets service provider computer 350 may send the digital wallet a list of financial institutions that are capable of aggregating funds from the multiple financial institutions (e.g., financial institution computers 211 through 214) that hold money associated with consumer digital asset account 320. The financial institutions on the list may be any suitable entities that have a partnership with digital assets service provider computer 350 and are interested in serving unbanked consumers. Consumer 220 may make a selection of a financial institution from the list displayed by their digital wallet application. In this exemplary case, consumer 220 may choose the financial institution associated with financial institution computer 715.

Based on the selection, digital assets service provider computer 350 may allow the financial institution computer 715 to manage money corresponding to consumer digital asset account 320 of consumer 220. Subsequently, financial institution computer 715 may send a request to transfer all of the money associated with consumer digital asset account 320 of consumer 220 held by various financial institutions (e.g., financial institution computers 211 through 214) to financial institution computer 715. In some embodiments, the request may be sent to digital assets service provider computer 350, which may then forward instructions to financial institution computer 211 through 214 to transfer the appropriate amount of money. In other embodiments, the request may be sent to each financial institution computer 211 through 214 along with an indication of approval from digital assets service provider computer 350.

The money associated with consumer digital asset account 320 of consumer 220 may then be aggregated by financial institution computer 715. In this exemplary case, a total of $20 may be aggregated by financial institution computer 715, where each of financial institution computers 211 through 214 transferred $5 to financial institution computer 211 through 214. It is understood that as more money is accumulated in consumer digital asset account 320 of consumer 220 in the future, financial institution computer 715 may be configured to request transfer of money in periodic intervals.

Digital assets service provider computer 350 may create a real-currency account for consumer 220. The real-currency account may be associated with information related to consumer digital asset account 320, such as an account identifier for consumer digital asset account 320 and identification information of consumer 220 (e.g., digital wallet username and password). Digital assets service provider computer 350 may send consumer 220 information related to their newly created real-currency account (e.g., account identifier) through their digital wallet. Subsequently, consumer 220 may be able to use an automated teller machine (ATM) hosted by financial institution computer 715 to withdraw cash of up to $20 from their consumer digital asset account 320.

While the enrollment process of consumer 220 is described in detail above, a similar enrollment process can be performed by consumer 230. Consumer 230 may also select financial institution computer 715, which may then aggregate a total of $12 from financial institution computers 211 through 214. Consumer 230 may then be able to use an ATM hosted by financial institution computer 715 to withdraw cash of up to $12 from their consumer digital asset account 320. In other embodiments, consumer 230 may select a different financial institution than that chosen by consumer 220 to aggregate their cash. In this case, consumer 230 may then use an ATM hosted by the financial institution that they chose in order to withdraw cash.

In other embodiments, consumers may not be provided an option to select the financial institution to aggregate their funds associated with their digital asset account. Instead, a financial institution may be pre-selected by digital assets service provider computer 350 based on various factors. For example, digital assets service provider computer 350 may designate for a consumer a financial institution that is located in a certain region based on a specific geo-location detected for the consumer.

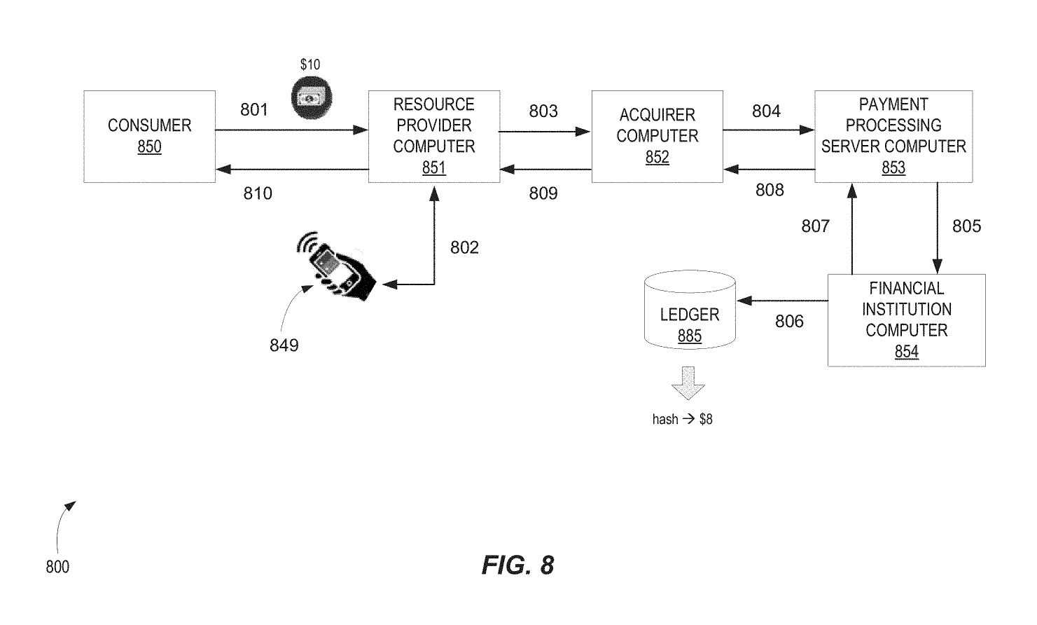

FIG. 8 shows a flow diagram 800 of another method of performing a transaction in which a consumer receives a digital asset for change according to embodiments of the present invention. FIG. 8 includes a consumer 850 operating a computing device 849, a resource provider computer 851 associated with a resource provider, an acquirer computer 852, a payment processing server computer 853, a financial institution computer 854, and a ledger 855. Financial institution computer 854 may run an application that enables it to issue digital assets. The method utilizes a transaction code corresponding to a “prepaid load” at the POS terminal. The transaction code may be supported as part of the ISO 8583 message standard. The method can enable certain steps involving consumer input to be eliminated when the digital asset is claimed.

Before the transaction is performed, a digital asset wallet activation process is performed by consumer 850. Consumer 850 may install a digital asset wallet application comprising a digital asset wallet (e.g., virtual digital asset card) onto computing device 849. Consumer 850 may be prompted to provide enrollment information for setup, such as an identifier (e.g., email), password. In some cases, other information may be requested from consumer 850 based on local regulations and banking requirements (e.g., know your customer), such as driver's license identifier, last 4 digits of social security number, which can be used to validate the identity of consumer 850, as well as to support password recovery scenarios or the like.

During activation of the digital wallet, an account number (e.g., PAN number) may be generated in association with the digital wallet. While the account number is not provided to consumer 850, a tokenized account number and cryptogram may be provided to the digital wallet when conducting transactions. In some embodiments, sensitive information related to the digital wallet (e.g., tokenized account number, limited use key (LUK), and user derived key (UDK)) may be securely stored on the cloud or may be encrypted and stored on the secure element of computing device 849. Initially, the digital wallet may have no balance and will not be usable.

At step 801, consumer 850 initiates a transaction with the resource provider. Consumer 850 may pay $10 in cash for the transaction, where the transaction amount is $2. Consumer 850 may notify an agent operating resource provider computer 851 to add the change amount of $8 for the transaction into their digital asset wallet.

At step 802, consumer 850 uses computing device 849 to send identification information associated with their digital wallet to resource provider computer 851. In some embodiments, consumer 850 may tap their computing device 849 at resource provider POS terminal device that is in communication with resource provider computer 851 using NFC to initiate transmission of the information. This can allow identification information related to the digital asset wallet on computing device 849 to be communicated to resource provider computer 851, which can then forward the information to other entities in subsequent steps.

At step 803, the agent enters a request for a prepaid load (or cash load) based on the request from consumer 850 into resource provider computer 851. Resource provider computer 851 may generate a message requesting a prepaid load transaction and send the message to acquirer computer 852. The message may be sent with an indication that the load is for an amount of $8 and identification information received in step 802.

At step 804, acquirer computer 852 generates a request message based on the message received from resource provider computer 851. In some embodiments, acquirer computer 852 may generate a “0200” message according to the ISO 8583 message standard that indicates a request for funds of $8 to be loaded to the digital asset wallet of consumer 850. Acquirer computer 852 may send the request message to payment processing server computer 853.

At step 805, payment processing server computer 853 sends the request message to financial institution computer 854. This may indicate to financial institution computer 854 that $8 is to be loaded from funds of acquirer computer 852 associated with resource provider computer 851 to the digital asset account of consumer 850.

At step 806, financial institution computer 854 generates a digital asset associated with the change amount and assigns the digital asset to the digital asset account of consumer 850. Financial institution computer 854 may run a digital assets application through which it can generate and distribute digital assets. In this case, the digital asset may be generated with a corresponding amount of $8.

Financial institution computer 854 may issue the generated digital asset to consumer 850 by updating ledger 885 to indicate that the digital asset was issued to the digital asset account of consumer 850 during the transaction. In this case, the transaction data included in the new entry of ledger 885 may comprise a public address of the receiver of the digital asset (consumer 850), the public address of the initiator of the digital asset request (e.g., resource provider computer 851), ID of acquirer initiating the request for the digital asset (e.g., acquirer computer 852), an amount corresponding to the change amount (e.g., $8), resource provider location, and transaction timestamp. The block chain management and ledger update flow may be similar to that described with respect to FIG. 5.

At step 807, financial institution computer 854 generates a response message and sends the response message to payment processing server computer 853. In some embodiments, the response message may be a “0210” message according to the ISO 8583 message standard that includes a response to the received request for funds. The response message may indicate that the requested funds were successfully loaded.

At step 808 and 809, payment processing server computer 853 sends the response message to acquirer computer 852, which then forwards the response message to resource provider computer 851. Resource provider computer 851 may process the response message to check that the funds were successfully loaded into the digital asset account of consumer 850.

At step 810, resource provider POS terminal device may print a receipt for consumer 850 indicating the change amount for the transaction. Consumer 850 may be able to view the updated balance on their digital asset wallet using their computing device 849, where the updated balance reflects a credit of an amount of $8 received as change for the transaction.

FIG. 9 shows a flow diagram 900 of a fast settlement process according to embodiments of the invention. FIG. 9 includes an acquirer computer 952 associated with a resource provider, a payment processing server computer 953, a digital assets service provider computer 955, and financial institution computers 954. Financial institution computers 954 may be entities that generate and issue digital assets. The fast settlement process may be used when a digital asset is claimed by the consumer for a transaction conducted with the resource provider and transferred to the digital asset account of the consumer. This enables the real currency corresponding to the transferred digital asset to be made available to the consumer in real-time.

At step 901, a digital asset is transferred to the consumer digital asset account. The transfer can involve several steps as described with respect to at least FIG. 5 or FIG. 8, including updating ledgers of transactions to indicate that the digital asset is issued to digital asset account of the consumer. After the records are updated to indicate the transfer of ownership of the digital asset, a fast settlement process may be initiated to enable funds associated with the digital asset can be made available to consumer in real-time.

At step 902, digital assets service provider computer 955 generates a fast settlement request for payment processing server computer 953. Payment processing server computer 953 may provide a settlement service that reports cleared transactions for each settlement participant. Typically, the settlement may be processed at a later time. However, the fast settlement request from digital assets service provider computer 955 can indicate that the funds are to be made available in real-time.

At step 903, payment processing server computer 953 sends a real-time settlement message to acquirer computer 952. This indicates to acquirer computer 952 that the settlement process being conducted for the transaction is a fast settlement process. Acquirer computer 952 may participate in the Single Message System, in which authorization, cleating, and settlement data are performed in a single operation. Thus, when acquirer computer 952 receives an indication that the transactions is authorized, the transaction is considered closed.

At step 904, payment processing server computer 953 sends a fast fund transfer request to the financial institution computer from financial institution computers 954 that issued the digital asset. Payment processing server computer 953 may generate settlement services files that include settlement information corresponding to the transaction. The settlement services files for the fast fund transfer request can include permissions data that enable the financial institution computer to provide the value associated with the digital asset to the consumer immediately. Thus, the amount credited to the digital asset account of the consumer as change for the transaction can be used by consumer in real-time, even though real currency may still be moved as part of the settlement process performed in batch at the end of the day.

A computer system may be utilized to implement any of the entities or components described above. Subsystems of the computer system may be interconnected via a system bus. Additional subsystems may include a printer, a keyboard, a fixed disk (or other memory comprising computer readable media), a monitor, which is coupled to a display adapter, and others. Peripherals and input/output (I/O) devices, which couple to an I/O controller (which can be a processor or other suitable controller), can be connected to the computer system by any number of means known in the art, such as by a serial port. For example, the serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. While the present invention has been described using a particular combination of hardware and software in the form of control logic and programming code and instructions, it should be recognized that other combinations of hardware and software are also within the scope of the present invention. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

In some embodiments, any of the entities described herein may be embodied by a computer that performs any or all of the functions and steps disclosed.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a service provider computer a request for a digital asset corresponding to an amount owed to a consumer for a transaction conducted between the consumer and a resource provider associated with a resource provider computer;
generating, by the service provider computer, the digital asset corresponding to the amount;
determining, by the service provider computer, a digital asset identifier associated with the digital asset, wherein the digital asset identifier is eventually provided to a computing device of the consumer;
receiving, by the service provider computer, the digital asset identifier from the computing device of the consumer;
sending, by the service provider computer to a financial institution computer associated with the resource provider, a request to update an unalterable electronic ledger of transactions managed by the financial institution computer, wherein the financial institution computer updates the unalterable electronic ledger of transactions to indicate the transfer of the digital asset from a digital asset account of the resource provider to a digital asset account of the consumer.

2. The method of claim 1, wherein the transaction is a first transaction, the resource provider is a first resource provider, the resource provider computer is a first resource provider computer, the financial institution computer is a first financial institution computer, the unalterable electronic ledger of transactions is a first unalterable electronic ledger of transactions, and wherein the method further comprises:
receiving, by the service provider computer from the computing device of the consumer, a request to pay for a second transaction using the digital asset, where the second transaction is conducted between the consumer and a second resource provider;
generating, by the service provider computer, a token associated with the digital asset;
sending, by the service provider computer, the token to the computing device;
receiving, by the service provider computer, the token provided by the consumer using their computing device;
sending, by the service provider computer to a second financial institution computer associated with the second resource provider, a request to update a second unalterable electronic ledger of transactions managed by the second financial institution computer, wherein the second financial institution computer updates the second unalterable electronic ledger of transactions to indicate the transfer of the digital asset from the digital asset account of the consumer to a digital asset account of the second resource provider.

3. The method of claim 1, wherein the digital asset identifier is a string of characters that is key-entered by the consumer or a scannable image that is scanned using the computing device.

4. The method of claim 3, further comprising:
sending, by the service provider computer to the first financial institution computer, a request to update the first unalterable electronic ledger of transactions managed by the first financial institution computer, wherein the first financial institution computer updates the unalterable electronic ledger of transactions to indicate the transfer of the digital asset from the digital asset account of the consumer to the digital asset account of the second resource provider.

5. The method of claim 1, wherein the unalterable electronic ledger of transactions is updated to include a new entry comprising identification information of the resource provider and its digital asset account, identification information of the consumer and its digital asset account, and the amount corresponding to the digital asset, wherein the new entry includes a digital signature of the resource provider computer.

6. The method of claim 5, wherein the digital signature is verifiable using a public key associated with the resource provider computer.

7. The method of claim 2, wherein the first unalterable electronic ledger of transactions and the second unalterable electronic ledger of transactions are in the form of block chains.

8. The method of claim 1, wherein the computing device of the consumer comprises a digital wallet application associated with the digital asset account of the consumer.

9. The method of claim 1, further comprising:
performing a fast settlement process for the transaction is performed in real-time.

10. The method of claim 9, wherein the amount associated with the digital asset is available for use by the consumer in real-time.

11. The method of claim 1, wherein the consumer pays for the transaction using cash.

12. The method of claim 1, further comprising:
receiving, by the service provider computer from the computing device of the consumer, a selection of a third financial institution computer to manage a total amount associated with digital assets corresponding to the digital asset account of the consumer; and
allowing, by the service provider computer, the selected third financial institution computer to aggregate the total amount associated with the digital asset account of the consumer.

13. The method of claim 12, wherein the consumer withdraws cash from an automated teller machine associated with the selected third financial institution computer, and wherein the value of the cash is debited from the digital asset account of the consumer.

14. A method comprising:
providing to a resource provider computer associated with a resource provider, a request to receive change for a transaction in the form of a digital asset, wherein the resource provider computer sends a request to generate the digital asset corresponding to a change amount to a service provider computer;
receiving, by a computing device, a digital asset identifier associated with the digital asset generated by the service provider computer; and
sending, by the computing device, the digital asset identifier to the service provider computer, wherein the service provider computer sends, to a financial institution computer associated with the resource provider, a request to update an unalterable electronic ledger of transactions managed by the financial institution computer, wherein the financial institution computer updates the unalterable electronic ledger of transactions to indicate the transfer of the digital asset from a digital asset account of the resource provider to a digital asset account of a consumer.

15. The method of claim 14, wherein the transaction is a first transaction, the resource provider is a first resource provider, the resource provider computer is a first resource provider computer, the unalterable electronic ledger of transactions is a first unalterable electronic ledger of transactions, and the financial institution computer is a first financial institution computer, further comprising:
sending, by the computing device to the service provider computer, a request to pay for a second transaction conducted with a second resource provider using the digital asset account of the consumer;
receiving, by the computing device, a token generated by the service provider computer corresponding to the digital asset;
providing, by the computing device, the token to the service provider computer, wherein the service provider computer sends, to a second financial institution computer associated with the second resource provider, a request to update a second unalterable electronic ledger of transactions managed by the second financial institution computer, wherein the second financial institution computer updates the second unalterable electronic ledger of transactions to indicate the transfer of the digital asset from the digital asset account of the consumer to a digital asset account of the second resource provider.

16. The method of claim 14, wherein the digital asset identifier is a string of characters that is key-entered by the consumer or a scannable image that is scanned using the computing device.

17. The method of claim 15, wherein the token is a string of characters that is key-entered by the consumer or a scannable image that is scanned using the computing device.

18. A service provider computer comprising:
a processor; and
a computer readable medium coupled to the processor, the computer readable medium comprising code, executable by the processor, to implement the method of claim 1.

19. A computing device comprising:
a processor; and
a computer readable medium coupled to the processor, the computer readable medium comprising code, executable by the processor, to implement the method of claim 14.

20. A method comprising:
receiving, by a service provider computer, a prepaid load request corresponding to an amount owed to a consumer for a transaction conducted between the consumer and a resource provider associated with a resource provider computer, wherein the prepaid load request is generated by the resource provider computer;
generating, by the service provider computer, a digital asset corresponding to the amount;
sending, by the service provider computer to a financial institution computer associated with the resource provider, a request to update an unalterable electronic ledger of transactions managed by the financial institution computer, wherein the financial institution computer updates the unalterable electronic ledger of transactions to indicate the transfer of the digital asset to a digital asset account of the consumer; and
sending, by the service provider computer, a prepaid load response indicating that the amount has been transferred.
